(19) United States
(12) Patent Application Publication
(10) Pub. No.: US 2005/0109458 A1
(43) Pub. Date: May 26, 2005

(54) Method of bonding two materials with a crosslinkable adhesive

(76) Inventors: Bruno D'Herbecourt, Bernay (FR); Annett Linemann, Bernay (FR)

Correspondence Address: Thomas F. Roland, Esq.;Arkema Inc., 2000 Market St., Philadelphia, PA, 19103, US

(21) Appl. No.: 10/992,940

(22) Filed: Nov. 19, 2004

Related U.S. Application Data
(60) Provisional application No. 60/540,465, filed on Jan. 30, 2004.

(30) Foreign Application Priority Data
Nov. 21, 2003 (FR) 03.13656

(51) Int. Cl. B32B 31/00

(52) U.S. Cl. 156/310

(57) ABSTRACT

The present invention relates to a method of bonding two materials with a crosslinkable adhesive, in which a composition (A) is placed on that side of the material (A) which has to bond to the other material (B), a composition (B) is placed on that side of the material (B) which has to bond to the other material (A), and the contact between compositions (A) and (B) and materials (A) and (B) in the presence of heat and optionally of pressure exerted on the materials produces a crosslinked adhesive which joins the two materials together. In one embodiment the compositions are in the form of a film, a mesh or a nonwoven.

This application claims benefit, under U.S.C. §119(a) of French National Application Number 03.13656, filed Nov. 21, 2003; and also claims benefit, under U.S.C. §119(e) of U.S. provisional application 60/540,465, filed Jan. 30, 2004.

### FIELD OF THE INVENTION

The present invention relates to a method of bonding two materials with a crosslinkable adhesive. More precisely, in the method of the invention, a composition (A) is placed on that side of the material (A) which has to bond to the other material (B), a composition (B) is placed on that side of the material (B) which has to bond to the other material (A), and the contact between compositions (A) and (B) and materials (A) and (B) in the presence of heat and optionally of pressure exerted on the materials produces a crosslinked adhesive which joins the two materials together.

### BACKGROUND OF THE INVENTION

Hot-melt adhesives are thermoplastics which are solid at room temperature but become viscous liquids when heated. These viscous liquids are applied to the surface of a first substrate and then this surface is covered with a second surface. Upon cooling, adhesion is obtained between the substrate and the second surface. These adhesives are denoted by the abbreviation HMA (hot-melt adhesives).

The bonds thus formed can be used at room temperature and are sufficient. However, when they are exposed to temperatures above room temperature, and approaching the melting point of the adhesive, the adhesion decreases and there is a risk of debonding.

This drawback may be remedied by crosslinking the adhesive once the bonding has taken place, thus the adhesive remains in the solid state when the temperature increases and approaches or exceeds the initial melting point of the adhesive before it was crosslinked. The prior art has described many solutions of this type.

Patent EP 940461 discloses an HMA consisting of polyethylene in which a reactive powder and a crosslinking agent are dispersed, these being such that they do not react until the polyethylene has melted. Patent EP 326444 discloses a fabric covered on one of its sides with an HMA adhesive consisting of a polymer in which an encapsulated crosslinking agent is dispersed. This fabric is placed on a material (for example another fabric) in such a way that the adhesive is towards the material and pressure is applied while heating. The fabric is bonded to the material and at the same time the adhesive is crosslinked. Patent JP1249873 (Application JP19880079799) discloses a crosslinkable adhesive based on a blocked isocyanate and a polyamine. Patent EP 373878 discloses an adhesive in the form of an acrylic resin modified by an amino amide mixed with a polyol and a radical initiator. Crosslinking is brought about by heating. Patent GB 2135673 discloses a woven glass fabric whose fibres are coated with an epoxy resin, this woven fabric then being coated with an amine-terminated polyamide. This woven fabric is placed between two materials that are hot-pressed in order to bond them together. U.S. Pat. No. 3,409,497 discloses a similar method, but the fibres are coated with an OH-terminated bisphenol and the fabric is covered with an epoxy resin.

The drawback of these techniques is that the two components of the adhesive must either be carefully separated, in order to prevent crosslinking before the two materials have been bonded, or the components of the adhesive must be carefully chosen so that there is no crosslinking prior to a defined temperature and/or the materials are brought fully together to create a definitive join. In addition, the components of these crosslinkable adhesives are not simple products.

A much simpler method has now been found, in which a composition (A) is placed on that side of the material (A) which has to bond to the other material (B), a composition (B) is placed on that side of the material (B) which has to bond to the other material (A), and the contact between compositions (A) and (B) and materials (A) and (B) in the presence of heat and optionally of pressure exerted on the materials produces a crosslinked adhesive which joins the two materials together.

### SUMMARY OF THE INVENTION

The present invention relates to a method of bonding two materials with a crosslinkable adhesive. More precisely, in the method of the invention, a composition (A) is placed on that side of the material (A) which has to bond to the other material (B), a composition (B) is placed on that side of the material (B) which has to bond to the other material (A), and the contact between compositions (A) and (B) and materials (A) and (B) in the presence of heat and optionally of pressure exerted on the materials produces a crosslinked adhesive which joins the two materials together.

In other words, compositions (A) and (B) are placed between the materials to be bonded, composition (A) being placed on the material (A) side and composition (B) being placed on the material (B) side. According to one advantageous embodiment, the compositions are in the form of a film, a mesh or a nonwoven. In the rest of the text, the film, mesh and nonwoven will be denoted by the term “film” or “web” for the sake of simplification. According to one particular embodiment, the films (A) and (B) may be adjacent (and not adhering to each other), but there is no reaction since the temperature is room temperature. The two films (A) and (B) may be attached by spots of adhesive or by heating the films (A) and (B) at only a few points in order to fasten the two films together and make them easier to handle.

According to another embodiment of the invention, composition (A) is fixed to that part of material (A) which has to bond to the other material (B) and composition (B) is fixed to that part of the material (B) which has to bond to the other material (A). In other words, the invention is a method of bonding two materials with a crosslinkable adhesive in which that part of the material (A) which has to bond to the other material (B) is coated with a composition (A), that part of the material (B) which has to bond to the other material (A) is coated with a composition (B), and the contact between compositions (A) and (B) in the presence of heat and optionally of pressure exerted on the materials produces a crosslinked adhesive which joins the two materials together.

Compositions (A) and (B) may be deposited in the melt state on the materials. According to an advantageous embodiment, at least one of these compositions and preferably both of them are in the form of a film, mesh or nonwoven. The film is fixed to the material by simple hot-pressing, without melting the film, and then the two materials are brought into contact via their part coated with the films, and heat is applied, pressure optionally being exerted on the materials.

It would not be outside the scope of the invention if only one of the compositions were to be fixed to one of the materials (for example, composition (A) to material (A)).

The method of the invention has many advantages:
the materials coated with the films are easily prepared—all that is required is to bring the two materials optionally coated with their films into contact with each other and to hot-press them in order to obtain the bond;
compositions (A) and (B) react irreversibly at the moment of bonding, thus the thermal resistance is improved at temperatures above the melting points of compositions (A) and (B) alone; and
it is possible to choose compositions (A) and (B) that exhibit good adhesion to materials (A) and (B) respectively.

The present invention also relates to each of the materials coated with the film (A) or (B) and to the article resulting from the bonding of materials (A) and (B).

### DETAILED DESCRIPTION OF THE INVENTION

With regard to materials (A) and (B), these may be any material such as wood, paper, board, metal, plastics and woven or nonwoven fabrics. The invention is particularly advantageous when at least one of the materials is a fabric.

With regard to compositions (A) and (B), these denote compositions which can be deposited in the melt state on the material or which can form a film and which, by mutual contact when hot, produce a crosslinked adhesive. Mention may be made, for example, of standard HMAs, provided that they each possess functional groups that cause crosslinking. The melting point of compositions (A) and (B) is around 60 to 150° C. Advantageously, compositions (A) and (B) are polymers or polymer blends. They may be in the form of a film, mesh or nonwoven. The film may be manufactured by the standard techniques in the technical field of thermoplastic polymers, namely extrusion, blow moulding and casting, that is to say the molten material is extruded through a flat die and the polymer is cooled and solidified by passing it over chilled rolls. The nonwoven may be manufactured using standard techniques from compositions (A) or (B) made in fibre form. For example, the compositions may be passed in the melt state through spinnerets, the fibres are collected on a cold plate, and the mutual contacting of the fibres, before they have completely cooled, bonds them together, forming a nonwoven. As regards the mesh, this may be considered as a film with holes or a fabric woven with fibres.

With regard to polymers (A), these may be, for example:
A1: copolyamides (coPA) and copolymers having copolyamide blocks and polyether blocks;
A2: COOH-terminated copolyamides and COOH-terminated copolymers having copolyamide blocks and polyether blocks;
A3: NH₂-terminated copolyamides and NH₂-terminated copolymers having copolyamide blocks and polyether blocks;
A4: acid-terminated copolyamides and acid-terminated copolymers having copolyamide blocks and polyether blocks, this acid having unsaturated bonds; and
A5: copolymers having copolyamide blocks and polyether blocks, in which the polyether blocks are polybutadiene blocks, advantageously the polyether blocks and the copolyamide blocks are linked by ester groups deriving from the reaction between the OH end groups of the polyether and the acid end groups of the copolyamide blocks.

These types A1 to A5 may contain a peroxide-type initiator.

With regard to polymers (B), mention may be made, for example, of:
B1: polymers carrying epoxy functional groups, such as ethylene/glycidyl methacrylate (GMA) copolymers and optionally ethylene/alkyl(meth)acrylate copolymers and epichloroidrin-based copolymers;
B2: polymers carrying carboxylic acid anhydride functional groups, such as ethylene/maleic anhydride (MAH) copolymers and optionally ethylene/alkyl(meth)acrylate copolymers, and polymers carrying carboxylic acid functional groups, such as ethylene/acrylic acid copolymers and optionally ethylene/alkyl(meth)acrylate copolymers;
B3: isocyanates (or polyisocynates) encapsulated in a polyolefin matrix;
B4: polyketones;
B5: polyureas, optionally in a polyolefin matrix;
B6: polycarbodiimides, optionally in a polyolefin matrix; and
B7: ester polyols carrying multiple acrylate groups, optionally in a polyolefin matrix.

According to one particular embodiment of the invention (B1) is either a copolymer of ethylene and an unsaturated epoxide or a polyolefin grated with an unsaturated epoxide.

As regards the polyolefin grated with an unsaturated epoxide, the term “polyolefin” is understood to mean polymers comprising olefin units, such as for example ethylene, propylene and 1-butene units, or any other α-olefin. For example, mention may be made of:
polyethylenes, such as LDPE, HDPE, LLDPE or VLDPE, polypropylene, ethylene/propylene copolymers, EPRs (ethylene/propylene rubbers) or metallocene PEs (copolymers obtained by monosite catalysis);
styrene/ethylene-butylene/styrene block copolymers (SEBS), styrene/butadiene/styrene block copolymers (SBS), styrene/isoprene/styrene block copolymers (SIS), styrene/ethylene-propylene/styrene block copolymers and ethylene-propylene-diene polymers (EPDM); and
copolymers of ethylene with at least one product chosen from salts or esters of unsaturated carboxylic acids, or vinyl esters of saturated carboxylic acids.

Advantageously, the polyolefin is chosen from LLDPE, VLDPE, polypropylene, ethylene/vinyl acetate copolymers and ethylene/alkyl(meth)acrylate copolymers. The density may advantageously be between 0.86 and 0.965 and the melt flow index (MFI) may be between 0.3 and 40 (in g/10 min at 190° C./2.16 kg).

With regard to copolymers of ethylene and an unsaturated epoxide, mention may be made, for example, of copolymers of ethylene with an alkyl(meth)acrylate and with an unsaturated epoxide, or copolymers of ethylene with a vinyl ester of a saturated carboxylic acid and with an unsaturated epoxide. The amount of epoxide may be up to 15% by weight of the copolymer and the amount of ethylene at least 50% by weight.

Advantageously (B1) is an ethylene/alkyl(meth)acrylate/unsaturated epoxide copolymer.

Preferably, the alkyl(meth)acrylate is such that the alkyl possesses 2 to carbon atoms.

The MFI (melt flow index) of (B1) may, for example, be between 0.1 and 50 (g/10 min at 190° C./2.16 kg).

Examples of alkyl acrylates or methacrylates that can be used are, in particular, methyl methacrylate, ethyl acrylate, n-butyl acrylate, isobutyl acrylate and 2-ethylhexyl acrylate. Examples of unsaturated epoxides that can be used are in particular:
aliphatic glycidyl esters and ethers, such as allyl glycidyl ether, vinyl glycidyl ether, glycidyl maleate, glycidyl itaconate, glycidyl acrylate and glycidyl methacrylate; and
alicyclic glycidyl esters and ethers, such as 2-cyclohexen-1-yl glycidyl ether, diglycidyl cyclohexene-4,5-dicarboxylate, glycidyl cyclohexene-4-carboxylate, glycidyl 2-methyl-5-norbornene-2-carboxylate and diglycidyl endo-cis-bicyclo-[2.2.1]-hept-5-ene-2,3-dicarboxylate.

According to one embodiment of the invention (B2) is a polymer containing ethylene and an unsaturated carboxylic acid anhydride.

(B2) is either a copolymer of ethylene with an unsaturated carboxylic acid anhydride or a polyolefin grafted with an unsaturated carboxylic acid anhydride.

The polyolefin may be chosen from the polyolefins that were mentioned above and have to be grated with an unsaturated epoxide.

Examples of unsaturated dicarboxylic acid anhydrides that can be used as constituents of (B2) are in particular maleic anhydride, itaconic anhydride, citraconic anhydride, and tetrahydrophthalic anhydride.

By way of examples, mention may be made of copolymers of ethylene with an alkyl(meth)acrylate and an unsaturated carboxylic acid anhydride and copolymers of ethylene with a vinyl ester of a saturated carboxylic acid and an unsaturated carboxylic acid anhydride.

The amount of unsaturated carboxylic anhydride may be up to 15% by weight of the copolymer and the amount of ethylene at least 50% by weight.

Advantageously, (B2) is an ethylene/alkyl(meth)acrylate/unsaturated carboxylic anhydride copolymer. Preferably, the alkyl(meth)acrylate is such that the alkyl possesses 2 to 10 carbon atoms.

The alkyl(meth)acrylate may be chosen from those mentioned above.

The MFI of (B) may be, for example, between 0.1 and 50 (g/10 min at 190° C./2.16 kg).

Irreversible bonding, with very good temperature withstand capability, is obtained by combining:
web A1 with web chosen from B1, B2, B3, B4 and B6;
web A2 with web chosen from B1, B3, and B6;
web A3 with web chosen from B1, B2, B3, B4, B5, B6 and B7;
web A4 with web chosen from B1 and B7; and
web A5 with B7.

### EXAMPLES

The following products were used:

LOTADER 7500: denotes an ethylene/ethylacrylate/maleic anhydride copolymer in 80/17/3 proportions by weight, having an MFI of 70 g/10 min at 2.16 kg/190° C. It is manufactured by high-pressure radical polymerization;

LOTADER AX8950: denotes an ethylene/methylacrylate/glycidyl methacrylate copolymer of 72.2/18.8/9 proportions by weight, having an MFI of 90 g/10 min at 2.16 kg/190° C. It is manufactured by high-pressure radical polymerization;

PLATAMID 1: denotes a 6,9/12 copolyamide in 30/70 proportions by weight, obtained by condensation of hexamethylenediamene, C₉ diacid and lauryllactam. It is di-COOH-terminated and the MFI is 15 g/10 min at 2.16 kg/160° C.;

PLATAMID 2: denotes a copolyamide essentially based on hexamethylenediamene, caprolactam, adipic acid, C₁₀ diacid and aminoundecanoic acid. The MFI is 9 g/10 min at 2.16 kg/150° C.; and

PLATAMID 3: denotes a 6/6,6/12 copolyamide in 40/20/40 proportions, obtained by condensation of hexamethylenediamene, adipic acid and lauryllactam.

PLATAMID and LOTADER films 50 μm in thickness were produced and then these films were bonded in a press under the following conditions:
60 s; 280 dN; T(Lotader side)=75° C.; T(Platamid side)=150° C.

The results are given in Tables 1 and 2 below, in which the gel content is proof of crosslinking.

TABLE 1

| | Film A | | |
|---|---|---|---|
| | PLATAMID 1 | | |
| Film B | Tₘ = 130-140° C. | | |
| LOTADER 7500 | PLATAMID 2 | | PALTAMID 3 |
| Tₘ = 76° C. | Tₘ =160° C. | | Tₘ = 110° C. |
| Tₘ | 150° C. | 173° C. | 174° C. |
| Gel content | 18.4% | 41.92% | 38.33% |

TABLE 2

| | |
|---|---|
| Film B | Film A |

| LOTADER AX8950 | PLATAMID 1 | PLATAMID 3 |
|---|---|---|
| Tₘ = 71° C. | Tₘ = 130-140° C. | Tₘ = 100° C. |
| Tₘ | 173-182° C. | 167-182° C. |
| Gel content | 41.99% | 50% |

1. Method of bonding two materials with a crosslinkable adhesive, comprising the steps of
1) placing a composition (A) on that side of the material (A) which has to bond to the other material (B);
2) placing a composition (B) on that side of the material (B) which has to bond to the other material (A); and
3) contacting compositions (A) and (B) and materials (A) and (B) in the presence of heat and optionally of pressure exerted on the materials to produce a crosslinked adhesive which joins the two materials together.

2. Method according to claim 1, in which compositions (A) and (B) are in the form of a film, a mesh or a nonwoven.

3. Method according to claim 2, in which the two compositions (A) and (B) are attached by spots of adhesive in order to fasten the two composiitonss together and make them easier to handle.

4. Method according to claim 2, in which the two compositions (A) and (B) are attached by heating the compositions (A) and (B) at only a few points in order to fasten the two compositions together and make them easier to handle.

5. Method of bonding two materials with a crosslinkable adhesive comprising the steps of:
1) coating that part of the material (A) which has to bond to the other material (B) with a composition (A);
2) coating that part of the material (B) which has to bond to the other material (A) with a composition (B); and
3) contacting compositions (A) and (B) in the presence of heat and optionally of pressure exerted on the materials to produce a crosslinked adhesive which joins the two materials together.

6. Method according to claim 5, in which compositions (A) and (B) are deposited in the melt state on the materials.

7. Method according to claim 5, in which at least one of compositions (A) or (B) is in the form of a film, mesh or nonwoven.

8. Method according to claim 7, in which the film, mesh or nonwoven is fixed to the material by simple hot-pressing without melting the film, mesh or nonwoven, and then the two materials are brought into contact via their part coated with the film, mesh or nonwoven, and heat is applied, pressure optionally being exerted on the materials.

9. Method according to claim 1, in which composition (A) is chosen from:
A1: copolyamides (coPA) and copolymers having copolyamide blocks and polyether blocks;
A2: COOH-terminated copolyamides and COOH-terminated copolymers having copolyamide blocks and polyether blocks;
A3: NH₂-terminated copolyamides and NH₂-terminated copolymers having copolyamide blocks and polyether blocks;
A4: acid-terminated copolyamides and acid-terminated copolymers having copolyamide blocks and polyether blocks, this acid having unsaturated bonds; and
A5: copolymers having copolyamide blocks and polyether blocks, in which the polyether blocks are polybutadiene blocks.

10. Method according to claim 1, in which composition (B) is chosen from:
B1: polymers carrying epoxy functional groups, such as ethylene/glycidyl methacrylate (GMA) copolymers and optionally ethylene/alkyl(meth)acrylate copolymers and epichloroidrin-based copolymers;
B2: polymers carrying carboxylic acid anhydride functional groups, such as ethylene/maleic anhydride (MAH) copolymers and optionally ethylene/alkyl (meth)acrylate copolymers, and polymers carrying carboxylic acid functional groups, such as ethylene/acrylic acid copolymers and optionally ethylene/alkyl(meth)acrylate copolymers;
B3: isocyanates (or polyisocynates) encapsulated in a polyolefin matrix;
B4: polyketones;
B5: polyureas, optionally in a polyolefin matrix;
B6: polycarbodiimides, optionally in a polyolefin matrix; and
B7: ester polyols carrying multiple acrylate groups, optionally in a polyolefin matrix.

11. Method according to claim 10, in which (B1) is an ethylene/alkyl (meth)acrylate/unsaturated epoxide copolymer.

12. Method according to claim 10, in which (B2) is an ethylene/alkyl (meth)acrylate/unsaturated carboxylic anhydride copolymer.

13. Method according to claim 5, in which composition (A) is chosen from:
A1: copolyamides (coPA) and copolymers having copolyamide blocks and polyether blocks;
A2: COOH-terminated copolyamides and COOH-terminated copolymers having copolyamide blocks and polyether blocks;
A3: NH₂-terminated copolyamides and NH₂-terminated copolymers having copolyamide blocks and polyether blocks;
A4: acid-terminated copolyamides and acid-terminated copolymers having copolyamide blocks and polyether blocks, this acid having unsaturated bonds; and
A5: copolymers having copolyamide blocks and polyether blocks, in which the polyether blocks are polybutadiene blocks.

14. Method according to claim 5, in which composition (B) is chosen from:
B1: polymers carrying epoxy functional groups, such as ethylene/glycidyl methacrylate (GMA) copolymers and optionally ethylene/alkyl(meth)acrylate copolymers and epichloroidrin-based copolymers;
B2: polymers carrying carboxylic acid anhydride functional groups, such as ethylene/maleic anhydride (MAH) copolymers and optionally ethylene/alkyl (meth)acrylate copolymers, and polymers carrying carboxylic acid functional groups, such as ethylene/acrylic acid copolymers and optionally ethylene/alkyl(meth)acrylate copolymers;
B3: isocyanates (or polyisocynates) encapsulated in a polyolefin matrix;
B4: polyketones;
B5: polyureas, optionally in a polyolefin matrix;
B6: polycarbodiimides, optionally in a polyolefin matrix; and
B7: ester polyols carrying multiple acrylate groups, optionally in a polyolefin matrix.

15. Method according to claim 14, in which (B1) is an ethylene/alkyl (meth)acrylate/unsaturated epoxide copolymer.

16. Method according to claim 14, in which (B2) is an ethylene/alkyl (meth)acrylate/unsaturated carboxylic anhydride copolymer.
